(19) United States
(12) Patent Application Publication
(10) Pub. No.: US 2016/0367065 A1
(43) Pub. Date: Dec. 22, 2016

(54) TEA BREWING APPARATUS

(71) Applicant: Peigen Jiang, Sammamish, WA (US)

(72) Inventor: Peigen Jiang, Sammamish, WA (US)

(21) Appl. No.: 14/741,456

(22) Filed: Jun. 17, 2015

(51) Int. Cl. A47J 31/20

(52) U.S. Cl. CPC A47J 31/20

(57) ABSTRACT

A tea brewing apparatus is disclosed which has a first dish having a rounded periphery and a perforated area, and a second dish also having a rounded periphery and engaging the first dish to form a container, the container forming a cavity for containing tea leaves yet being able to accept water through the perforated area, and the container being able to rest freely on bottom of a tea brewing mug even when the mug is tilted slightly over horizontal position.

### BACKGROUND

The present invention relates generally to tea brewing, and, more particularly, to an apparatus for containing tea leaves during brewing.

Brewing leaf tea is generally regarded as more desirable for retaining tea's natural fragrance and taste. However, preventing tea leaf from being poured out with tea water and controlling brewing time remain to be a challenge.

As such, what is desired is tea brewing apparatus that can contain tea leaves and is easy to use.

### BRIEF DESCRIPTION OF THE DRAWING

FIG. 1 is a cross-sectional view of a tea brewing mug with a leaf tea basket sitting at the bottom thereof according to an embodiment of the present disclosure.

FIG. 2 illustrates a bottom disk of the leaf tea basket of FIG. 1.

FIG. 3 illustrates a locking mechanism of the leaf tea basket of FIG. 1.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to a leaf tea brewing apparatus. Preferred embodiments of the present invention will be described hereinafter with reference to the attached drawings.

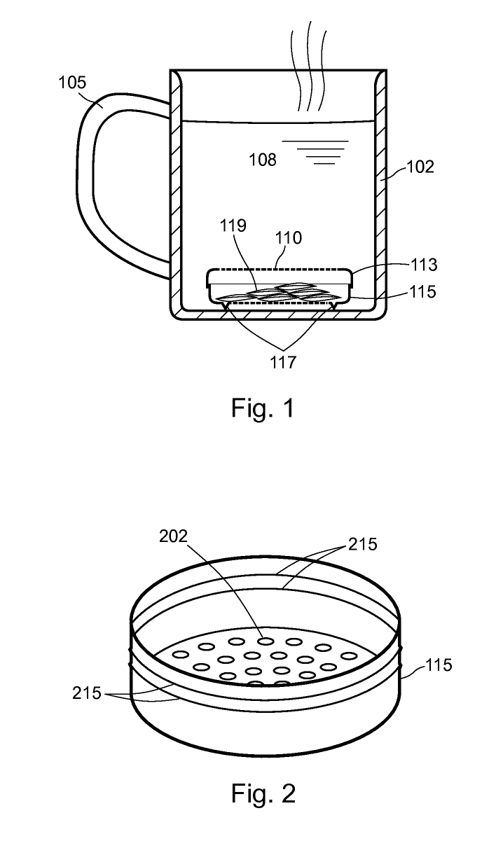

FIG. 1 is a cross-sectional view of a tea brewing mug 102 with a leaf tea basket 110 sitting at the bottom thereof according to an embodiment of the present disclosure. During tea brewing operation, the mug 102 is filled with hot water 108. A handle 105 remains not heated for easy carrying of the mug 102. The leaf tea basket 110 has a top disk 113 and a bottom disk 115. When engaged, the top disk 113 and the bottom disk 115 form a cavity for containing tea leaves 119. There are small holes formed on the top disk 113 or both the top disk 113 and the bottom disk 115 for accepting water into and out of the leaf tea basket 110.

Referring again to FIG. 1, the bottom disk 115 of the tea leaf basket 110 has a plurality of protruding members 117 for lifting the leaf tea basket 110 away from the bottom surface of the mug 102. With a gap between the leaf tea basket 110 and the bottom surface of the mug 102, water can enter the leaf tea basket 110 from the bottom, and the bottom surface of the mug 102 will get less stained by the tea.

As shown in FIG. 1, horizontal dimension of the leaf tea basket 110 is significantly smaller than inner diameter of the mug 102, so that a user can use a utensil (not shown), such as a spoon or a folk, to take out the leaf tea basket 110 from the mug 102 when the user chooses to stop brewing the tea. In another embodiment, a string (not shown) with one end attached to the leaf tea basket 110 and another end fastened to the handle 105 may be used to lift the leaf tea basket 110 out of the mug 102.

As shown in FIG. 1, height of the leaf tea container 110 is much smaller, at least two times smaller, than width or diameter of the leaf tea container 110. In embodiments, height of the leaf tea container 110 is only about two centimeters (2 cm), so that a user can leave the leaf tea basket 110 in the mug 102 while drinking tea therefrom.

FIG. 2 illustrates the bottom disk 115 of the leaf tea basket 110 of FIG. 1. The bottom disk 115 is exemplarily perforated with numerous holes 202 at the bottom so that water can sift through while tea leaves are contained. The top disk 113 (not shown in FIG. 2) has a similar structure.

As shown in FIG. 2, the bottom disk 115 is a circular shaped shallow column—so is the top disk 113, as mug 102 is generally also a circular shaped column, so that the leaf tea basket 110 can be snuggly fitted into the mug 102, and have significant fiction between the side walls of the two so that the leaf tea basket 110 remains at the bottom of the mug 102 even when the mug 102 is tilted slightly over horizontal position to completely pour water out.

Referring again to FIG. 2, in order to engage the top disk 113 of the leaf tea basket 110, screw threads 215 are formed on the side wall of the bottom disk 115. Corresponding screw threads (not shown) are also formed on side wall of the top disk 113, so that the top disk 113 can be screwed onto the bottom disk 115 forming a closed leaf tea basket 110. Due to the small height and rounded side wall, when closed, the leaf tea basket 110 is exemplarily shaped like an ice hockey puck.

In embodiments, the side wall of either the top disk 113 or the bottom disk 115 can also be perforated. The side walls are also straight and perpendicular to the bottom surface of the bottom disk 115, so that the leaf tea container 110 can better stand on the side wall of the mug 102 when the mug 102 is tilted in a horizontal position. Materials used for making the leaf tea basket 110 have to be heat and corrosion resistant and are preferably rigid. Stainless steel sheet stamped into desired shape can be one of such materials.

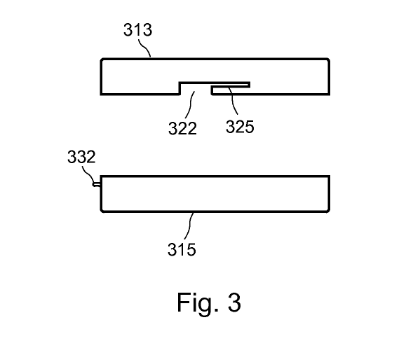

FIG. 3 illustrates another locking mechanism of the leaf tea basket 110 of FIG. 1. A top disk 313 has a notch 322 that leads to a horizontal slot 325 both formed on side wall of the top disk 313. A bottom disk 315 has a tap 332 protruding from the side wall of the bottom disk 315. When aligned, the protruding tab 332 fits into the notch 322. With a twist, the protruding tab 332 can slide into the slot 325, so that the top disk 313 and the bottom disk 315 are locked together. In embodiments, two or more notch-and-tab pairs can be formed on respective locations of the top disk 313 and bottom disk 315; and notches can be formed on the bottom disk 315 while tabs can be formed on the top disk 313.

While this disclosure has been particularly shown and described with references to exemplary embodiments thereof, it shall be understood by those skilled in the art that various changes in form and details may be made therein without departing from the spirit of the claimed embodiments.

What is claimed is:

1. A tea brewing apparatus comprising:
a first dish having a rounded periphery and a perforated area; and
a second dish also having a rounded periphery and engaging the first dish to form a container, the container forming a cavity for containing tea leaves yet being able to accept water through the perforated area, and the container being able to rest freely on bottom of a tea brewing mug even when the mug is tilted slightly over horizontal position.

2. The tea brewing apparatus of claim 1, wherein the second dish also has a perforated area.

3. The tea brewing apparatus of claim 1, wherein the second dish has a plurality of protruding members for maintaining a gap between the second dish and the bottom of the mug.

4. The tea brewing apparatus of claim 1, wherein the first dish and the second dish are engaged by screw threads.

5. The tea brewing apparatus of claim 1, wherein the first dish has a notch leading to a substantially horizontal slot on a side wall thereof, and the second dish has a tab protruding from a side wall thereof, wherein the tab can fit into the notch and slide into the horizontal slot for locking the first dish and the second dish together.

6. The tea brewing apparatus of claim 1, wherein a height of the container is at least two times smaller than a diameter of the container.

7. The tea brewing apparatus of claim 1, wherein the container is shaped like an ice hockey puck.

8. A tea brewing apparatus comprising:
a first dish having a rounded periphery and a perforated area; and
a second dish also having a rounded periphery and a perforated area, the second dish engaging the first dish to form a container, the container forming a cavity for containing tea leaves yet being able to accept water through the perforated areas, and the container being able to rest freely on bottom of a tea brewing mug even when the mug is tilted slightly over horizontal position.

9. The tea brewing apparatus of claim 8, wherein the second dish has a plurality of protruding members for maintaining a gap between the second dish and the bottom of the mug.

10. The tea brewing apparatus of claim 8, wherein the first dish and the second dish are engaged by screw threads.

11. The tea brewing apparatus of claim 8, wherein the first dish has a notch leading to a substantially horizontal slot on a side wall thereof, and the second dish has a tab protruding from a side wall thereof, wherein the tab can fit into the notch and slide into the horizontal slot for locking the first dish and the second dish together.

12. The tea brewing apparatus of claim 8, wherein a height of the container is at least two times smaller than a diameter of the container.

13. The tea brewing apparatus of claim 8, wherein the container is shaped like an ice hockey puck.

14. A tea brewing apparatus comprising:
a first dish having a rounded periphery and a perforated area; and
a second dish also having a rounded periphery and a perforated area, the second dish engaging the first dish to form an ice-hockey-puck-shaped container, the container forming a cavity for containing tea leaves yet being able to accept water through the perforated areas, and the container being able to rest freely on bottom of a tea brewing mug even when the mug is tilted slightly over horizontal position.

15. The tea brewing apparatus of claim 14, wherein the second dish has a plurality of protruding members for maintaining a gap between the second dish and the bottom of the mug.

16. The tea brewing apparatus of claim 14, wherein the first dish and the second dish are engaged by screw threads.

17. The tea brewing apparatus of claim 14, wherein the first dish has a notch leading to a substantially horizontal slot on a side wall thereof, and the second dish has a tab protruding from a side wall thereof, wherein the tab can fit into the notch and slide into the horizontal slot for locking the first dish and the second dish together.

18. The tea brewing apparatus of claim 14, wherein a height of the container is at least two times smaller than a diameter of the container.
